(19) United States
(12) Patent Application Publication
(10) Pub. No.: US 2011/0215559 A1
(43) Pub. Date: Sep. 8, 2011

(54) AIRBAG CONFIGURATION FOR A MOTOR VEHICLE

(75) Inventor: Ulrich RICK, Braunweiler (DE)

(73) Assignee: GM GLOBAL TECHNOLOGY OPERATIONS LLC, Detroit, MI (US)

(21) Appl. No.: 13/041,590

(22) Filed: Mar. 7, 2011

(30) Foreign Application Priority Data
Mar. 5, 2010 (DE) 102010010393.4

(51) Int. Cl. B60R 21/26

(52) U.S. Cl. 280/741

(57) ABSTRACT

An airbag configuration is provided for a motor vehicle, having an airbag and a filling device for filling the airbag, the airbag configuration being provided for an installed location in the motor vehicle, in which an airbag reserve is situated in an unfilled storage position above a lower edge of the filling device.

### CROSS-REFERENCE TO RELATED APPLICATION

This application claims priority to German Patent Application No. 102010010393.4, filed Mar. 5, 2010, which is incorporated herein by reference in its entirety.

### TECHNICAL FIELD

The technical field relates to an airbag configuration for a motor vehicle and a motor vehicle having such an airbag configuration.

### BACKGROUND

An airbag configuration is known from DE 201 07 578 U1, which forms the species, in which an airbag reserve, in an unfilled storage position, is situated folded in a zigzag adjacent to a gas distribution hose or tube, which is in turn connected to a gas generator. Upon activation, the gas generator fills the airbag via the gas distribution hose, which thus inflates in front of a side window of the vehicle and protects passengers in the event of an accident. The folded airbag reserve is pulled layer-by-layer out of its storage position and unfolded.

In the exemplary embodiments of DE 201 07 578 U1, the airbag reserve is situated essentially between the gas distribution hose and the vehicle outer side. The vertical layers of the airbag reserve protrude below the lower edge of the gas distribution hose. This results in a suboptimal filling characteristic.

Therefore, at least one object is to improve an airbag configuration. In addition, other objects, desirable features and characteristics will become apparent from the subsequent summary and detailed description, and the appended claims, taken in conjunction with the accompanying drawings and this background.

### SUMMARY

An airbag configuration has an airbag and a filling device for filling the airbag. In a preferred embodiment, the filling device is formed by a cable-type gas generator, which can be entirely or partially situated in the airbag, so that a separate filling tube or a separate filling hose can be dispensed with. A cable-type gas generator has a single-layer or multilayered outer envelope having outlet openings toward the airbag interior and a propellant core received in the outer envelope, which generates gas for filling the airbag upon triggering, which exits from the outlet openings therein. The propellant can be situated like a core in a preferably flexible and/or cylindrical tube, for example, which is extruded in particular, and which can preferably be produced from plastic. Alternatively, a filling device can also be formed by a filling tube or a filling hose, using which a gas generator is connected to the airbag interior, and/or by a gas generator of a different construction.

In the unfilled state, the airbag entirely or partially encloses the filling device using a filling device receptacle area and additionally has an airbag reserve. If gas exits from the filling device, the filling device receptacle area is at least partially moved away from the filling device in the so-called firing direction and the airbag reserve is thus pulled along or expended from its storage position. If the airbag reserve is folded in one or more layers to save storage space in the unfilled storage position, it is unfolded during filling, preferably layer-by-layer.

The airbag configuration is installed in a location in the motor vehicle and/or prepared for such an installation location, for example, by appropriate shaping of a housing and/or corresponding fastening devices such as tabs, pins, buttons, adhesive or soldered surfaces, hooks, and/or the like, in which the airbag reserve is situated in its unfilled storage position above a lower edge of the filling device. This can improve the filling characteristic, since now the airbag reserve (layers) are pulled downward toward the filling device using a vertical component during filling of the airbag. In order to improve the filling or unfolding characteristic still further, a defined withdrawal channel, for example, through an opening in an airbag housing, can be provided above the lower edge of the filling device, through which the airbag reserve is pulled along in a predefined way and toward the airbag unfolding in the passenger compartment.

In a preferred embodiment, the airbag reserve is situated on the side of the filling device facing toward the vehicle interior. Together with the configuration according to the invention above the lower edge of the filling device, this can advantageously increase the head freedom in the vehicle interior. Specifically, if the airbag is provided, for example, as a so-called curtain airbag, for the purpose of extending from above in front of at least one window of the motor vehicle in the filled state, and the airbag configuration is situated in the lateral roof area of the motor vehicle for this purpose, the lower edge of the airbag reserve, which recedes from the vehicle outer side to the vehicle interior in relation to the filling device on the vehicle outer side, allows a higher head line toward the vehicle interior.

In order to still further reduce the delimitation of the passenger compartment height downward by the airbag reserve extending toward the vehicle interior, i.e., to increase the head freedom in the vehicle interior, according to a preferred embodiment, the airbag reserve extends at least essentially flatly in one or more layers away from the filling device in the unfilled storage position. However, folding in the vertical direction can similarly be provided, if the vertical layers of the airbag reserve are situated according to the invention above the lower edge of the filling device.

The airbag configuration can have a housing to receive the filling device and/or the unfilled airbag reserve in the storage position and can be fastened using it in the vehicle. Similarly, the filling device, in particular an outer envelope of a cable-type gas generator, can also be attached directly to the vehicle and can also fix the airbag enclosing it. The airbag configuration can be permanently or removably fastened on a vehicle structure, in particular a vehicle body structure such as a roof girder, on a vehicle roof lining, and/or a roof module of the motor vehicle, in particular integrated thereon.

### BRIEF DESCRIPTION OF THE DRAWINGS

The present invention will hereinafter be described in conjunction with the following drawing figures, wherein like numerals denote like elements, and:

FIG. 1 shows an airbag configuration in the storage position in a motor vehicle according to an embodiment of the present invention; and

FIG. 2 shows the airbag configuration of FIG. 1 during filling of the airbag.

### DETAILED DESCRIPTION

The following detailed description is merely exemplary in nature and is not intended to limit application and uses. Furthermore, there is no intention to be bound by any theory presented in the preceding background or summary or the following detailed description.

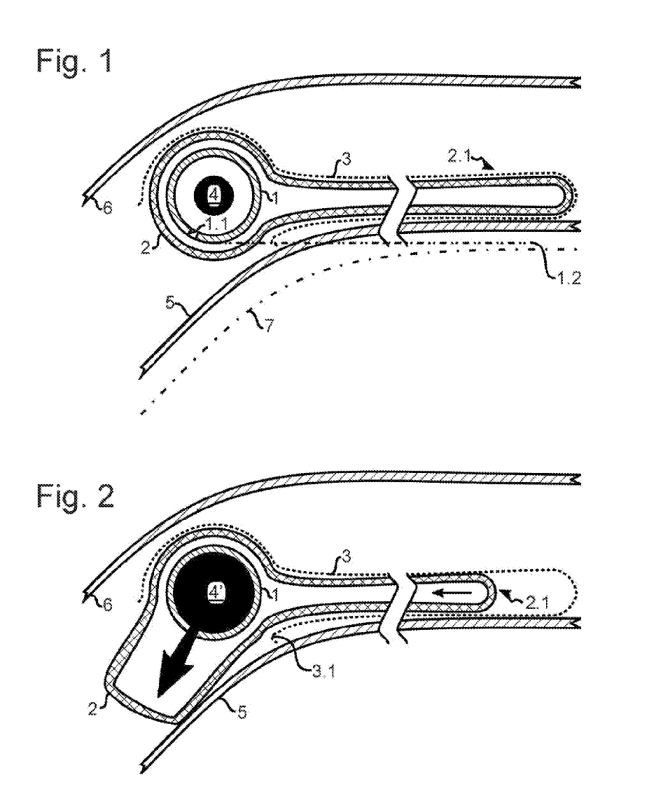

FIG. 1 shows a detail of the lateral roof area of a motor vehicle (not shown otherwise), having a roof lining 5, which delimits the passenger compartment on top, and a roof skin 6. The roof lining sinks toward the vehicle outer side (to the left in FIG. 1) and thus defines a head line indicated by a dot-dash line. An airbag housing 3, which is indicated by dashed lines in FIG. 1, FIG. 2, is situated in an installed location between roof skin 6 and roof lining, and, for example, connected to the vehicle structure and/or the vehicle roof lining via screw, catch, adhesive, or soldered connections (not shown). An airbag 2, in which a cable-type gas generator 1 is in turn accommodated, is accommodated in the housing 3. Cable-type gas generator 1, airbag 2, and housing 3 extend in the vehicle longitudinal direction, i.e., perpendicular to the plane of the drawing, essentially over the areas of the side windows.

The cable-type gas generator 1 has a cylindrical flexible plastic tube, in which an extruded propellant core 4 is situated like a core. In the unfilled state, the airbag 2 encloses the cable-type gas generator 1 using a filling device receptacle area. Furthermore, the airbag 2 has an airbag reserve 2.1, which is situated folded in two layers in an unfilled storage position on the side of the cable-type gas generator 1 facing toward the vehicle interior (on the right in FIG. 1) and extends essentially flatly away from this filling device toward the vehicle interior (to the right in FIG. 1).

The airbag reserve 2.1 is situated above a lower edge of the cable-type gas generator 1, as indicated in FIG. 1 by the dash-double-dot line. The lower edge toward the vehicle interior claimed by the airbag configuration thus becomes higher and therefore ensures a higher, more comfortable head line 7.

FIG. 2 shows the state during the filling of the airbag as the result of an accident. For this purpose, the propellant 4 of the cable-type gas generator 1 is ignited. The resulting gas exits through outlet openings 1.1 in the outer envelope into the airbag 2 and fills it. The lower filling device receptacle area of the airbag is moved downward in front of the side window in the firing direction indicated by a gas exit arrow in FIG. 2 and pulls along the airbag reserve 2.1, which is situated flatly adjacent to the cable-type gas generator 1 and over its lower edge in the unfilled storage position, out of the storage position, as indicated in FIG. 2 by a left arrow. The filling or unfolding characteristic is optimized by this pulling downward from of a position to the cable-type gas generator 1 which is elevated in relation to the lower edge, the influence of the folding for the unfolding characteristic or kinematics being reduced.

The firing direction is predefined by the outflow direction of the gas out of the cable-type gas generator 1 and/or the location and orientation of the outlet openings 1.1. In order to optimize the filling or unfolding characteristic still further, the housing 3 defines a withdrawal channel 3.1 above the lower edge of the cable-type gas generator 1.

In an alteration (not shown), the housing 3 can be dispensed with. The cable-type gas generator 1 can then be fastened directly, for example, via pins, on the roof skin 6 and/or the roof lining 5 and can also fix the airbag 2 surrounding it. The airbag reserve 2.1 can be situated in a corresponding cavity in the vehicle roof or between roof skin and roof lining 5, 6. A defined withdrawal channel 3.1 can also be provided by the roof lining 5 in an advantageous alteration. In a further alteration (not shown), the airbag reserve 2.1 can also be situated folded in a zigzag adjacent to the cable-type gas generator, the folded layers being able to be oriented essentially perpendicularly to the firing direction or vertically, for example.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An airbag configuration for a motor vehicle, comprising:
an airbag;
a filling device configured to fill the airbag; and
an airbag reserve situated in an unfilled storage position above a lower edge of the filling device.

2. The airbag configuration according to claim 1, wherein the airbag reserve is situated on a side of the filling device facing toward an interior of the motor vehicle.

3. The airbag configuration according to claim 1, wherein the airbag reserve extends essentially flatly away from the filling device in the unfilled storage position.

4. The airbag configuration according to claim 1, wherein the airbag reserve is folded in a layer in the unfilled storage position.

5. The airbag configuration according to claim 1, wherein the airbag reserve is folded in a plurality of layers in the unfilled storage position.

6. The airbag configuration according to claim 1, further comprising a housing configured to receive the filling device in the unfilled storage position.

7. The airbag configuration according to claim 1, further comprising a housing configured to receive an unfilled airbag reserve in the unfilled storage position.

8. The airbag configuration according to claim 1, further comprising a defined withdrawal channel above the lower edge of the filling device.

9. The airbag configuration according to claim 1, wherein the filling device comprises a cable-type gas generator that is at least partially situated in the airbag.

10. A motor vehicle, comprising:
an airbag configuration, comprising:
an airbag;
a filling device configured to fill the airbag; and
an airbag reserve situated in an unfilled storage position above a lower edge of the filling device; and
a location in the motor vehicle in which the airbag reserve is situated in the unfilled storage position above the lower edge of the filling device.

11. The motor vehicle according to claim 10, wherein the airbag configuration is fastened on a vehicle structure.

12. The motor vehicle according to claim 10, wherein the airbag configuration is fastened on a vehicle roof lining.

13. The motor vehicle according to claim 10, wherein the airbag configuration is fastened on a roof module of the motor vehicle.

14. The motor vehicle according to claim 10, wherein the airbag extends from above and in front of a window of the motor vehicle in a filled state.

15. The motor vehicle according to claim 10, wherein the airbag reserve is situated on a side of the filling device facing toward an interior of the motor vehicle.

16. The motor vehicle according to claim 10, wherein the airbag reserve extends essentially flatly away from the filling device in the unfilled storage position.

17. The motor vehicle according to claim 10, wherein the airbag reserve is folded in a layer in the unfilled storage position.

18. The motor vehicle according to claim 10, wherein the airbag reserve is folded in a plurality of layers in the unfilled storage position.

19. The motor vehicle according to claim 10, further comprising a housing configured to receive the filling device in the unfilled storage position.

20. The motor vehicle according to claim 10, further comprising a housing configured to receive an unfilled airbag reserve in the unfilled storage position.
